(19) United States
(12) Patent Application Publication
(10) Pub. No.: US 2007/0016431 A1
(43) Pub. Date: Jan. 18, 2007

(54) Method and apparatus for managing intellectual property

(75) Inventors: Umesh M. Desai, Austin, TX (US); Melynda Ward, Lakeway, TX (US); Paul R. McLaughlin, Round Rock, TX (US); Albert P. Wilhelm, Austin, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/182,461

(22) Filed: Jul. 15, 2005

(51) Int. Cl. G06Q 99/00

(52) U.S. Cl. 705/1

(57) ABSTRACT

The present invention provides a method and apparatus for processing ideas and managing intellectual property assets. The present invention provides a patent portfolio development portal for control and implementation of a workflow for the management of ideas such as intellectual property assets. The intellectual property assets comprise proprietary concepts and ideas captured or described in documents which are filed as applications for patent, trade marks, service marks or copyright. In the case of ideas, the intellectual property assets may also be published in defensive publications or held privately as trade secrets. The present invention provides an interface for comparing an intellectual property concept to other intellectual property concepts in a data base. The comparison enables easy access to similar and related intellectual property concepts so that similar concepts can be used to boot strap descriptions of new ideas based on improvements over and new combinations of other ideas.

### BACKGROUND OF THE INVENTION

1. Field of the Invention

The present invention relates to a computer-implemented method and apparatus for facilitating the preparation of invention documents, such as patent applications, securing intellectual property rights, and managing intellectual property assets, including pending patent applications and issued or granted patents.

2. Description of the Related Art

As the world economy has become more information and technology oriented, patents and other intellectual property are of growing importance. In order to secure such intellectual property rights, appropriate paperwork needs to be completed and filed in an intellectual property office. For example, in order to secure patent protection within the United States, a patent application describing and claiming an invention needs to be filed in the U.S. Patent and Trademark Office (hereinafter “USPTO”). Once filed, previously established rules and guidelines are followed by a Patent Examiner to determine whether or not patent rights to the invention should be granted. Typically, the process for obtaining these rights includes communications between the patentee and the patent office with many of such communications requiring a response within a given time period.

The patent business is rapidly growing. Hundreds of thousands of new patent applications are filed in the U.S. Patent and Trademark Office every year, and millions of new patent applications are filed in the rest of the world's patent offices. Driven by an increase in patent infringement judgments and patent royalty revenues, these numbers are expected to increase 20% per year. The patent process is generally managed by a corporate in-house legal team (comprised of attorneys, paralegals, and administrative assistants) aided by outside counsel and a patent review committee. As the demand increases, the importance of providing centralized access to information that eliminates duplication of effort (and saves resources) becomes increasingly important. An important step toward increasing efficiency is to allow for the creation and maintenance of data (including case information, bibliographic data, docketing data, prior art and other types of data or information) in a centralized location (e.g., in one file folder) from where it can be accessed, either locally or remotely, by multiple users of the data. However, not everyone should have access to the same data or even the same degree of access. A project should only be accessed by those with a need to know.

### SUMMARY OF THE INVENTION

The present invention provides a method and apparatus for processing and managing intellectual property and descriptions of ideas. The present invention provides a patent portfolio development portal for control and implementation of a complete workflow for the management of intellectual property assets. The intellectual property assets comprise proprietary concepts and ideas described in documents which are processed and filed as applications for patents, trade marks, service marks and/or copyrights. Proprietary concepts may also be published in defensive publications or held privately as a trade secret. The present invention provides an interface for comparing an intellectual property concept such as an invention described in an invention disclosure form, to other intellectual property concepts in a data base. The comparison enables easy access to similar and related intellectual property concepts so that similar concepts can be used to boot strap descriptions of new ideas based on improvements over and new combinations of other intellectual property concepts.

The present invention also provides an interface for scoring or evaluating an input such as an intellectual property concept or an outside counsel's performance. A set of configurable and fixed business rules is provided for evaluation of the input. A fixed business rule comprises a hard coded algorithm embedded in an application. A configurable business rule comprises application business logic/work-flow determined by user entered variables resulting in dynamic algorithms. The input, i.e. concept, can be viewed, evaluated and critiqued by a plurality of observers with access to the patent portfolio portal. Intellectual property concepts are described in an invention disclosure form (IDF). The terms intellectual property concept and IDF are used interchangeably herein. The present invention also provides for automatic identification and entry of keywords associated with an intellectual property concept. The keywords identify the key elements such as related technology or markets associated with the intellectual property concept relating to technology, or markets. The keywords enable users to find a correlated relationship in a data base of IDFs between an object IDF describing a particular intellectual property concept and other IDFs or patent concepts which contain the same or similar key words. A degree of relatedness between IDFs and/or intellectual property concepts is estimated by the degree of keyword correlation between intellectual property concepts. Key words can also be weighted and/or limited to a specific number of key words, enabling a user to focus on a particular set of keywords. Prior art can also be identified by key words found in the prior art and associated with the intellectual property concept.

In one aspect, the present invention provides a method and apparatus for classifying intellectual property, by accessing a description of the intellectual property; identifying a keyword in the description; and classifying the intellectual property based on the keyword. In another aspect of the invention, classifying further comprises inferring from the keyword a category for the intellectual property comprising at least one of the set consisting of a technology, market and product. In another aspect of the invention, classifying further comprises finding the keyword in another document to identify a related document relating to the intellectual property. In another aspect of the invention, classifying further comprises ranking a plurality of related documents based on a weight of at least one of the set consisting of a keyword weight and a target weight.

The documents comprise at least one of the set consisting of issued patents, patent applications, publications and additional intellectual property descriptions. In another aspect of the invention, classifying further comprises generating a password that allows access to the description of the intellectual property and the related document. In another aspect of the invention, classifying further comprises generating a proposed information disclosure statement including the related document. In another aspect of the invention, classifying further comprises assigning a developer to the intellectual property based on at least one of the set consisting of competence in the technology and available bandwidth. Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings, in which like elements have been given like numerals.

FIG. 1 illustrates an environment suitable for implementing an example of the present invention;

FIG. 2 illustrates overall functions performed in an example of the invention;

FIG. 3 illustrates functions and notices performed in an example of the invention;

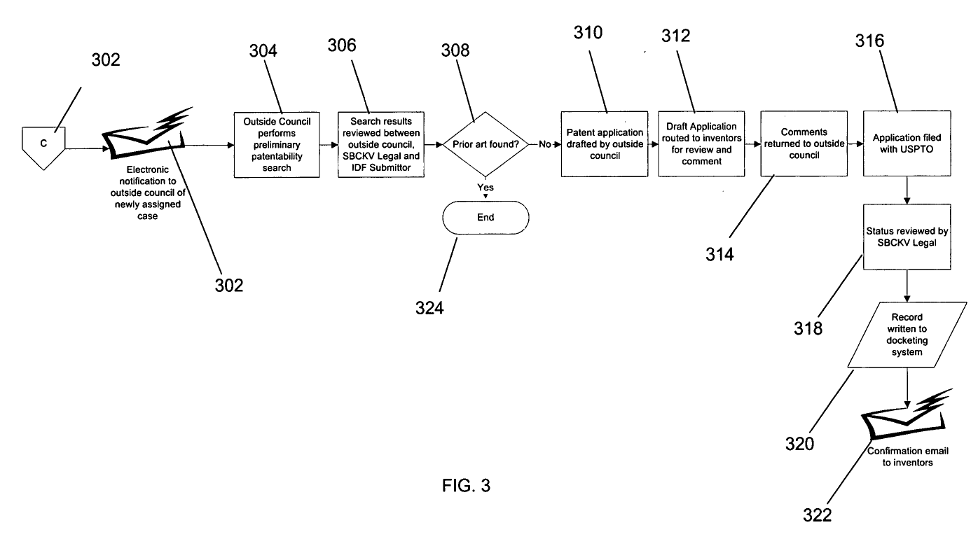

FIG. 4 illustrates functions performed in selecting keywords in an IDF in an example of the invention;

FIG. 5 illustrates functions performed in evaluating an IDF in an example of the invention;

FIG. 6 illustrates an example of an evaluation matrix in an example of the present invention;

FIG. 7 illustrates functions performed in evaluating outside counsel in an example of the invention;

FIG. 8 illustrates functions performed in assigning an IDF to outside counsel in an example of the invention; and

FIG. 9 illustrates functions performed in generating an information disclosure statement in an example of the invention.

### DETAILED DESCRIPTION OF THE INVENTION

In view of the above, the present invention through one or more of its various aspects and/or embodiments is presented to provide one or more advantages, such as those noted below.

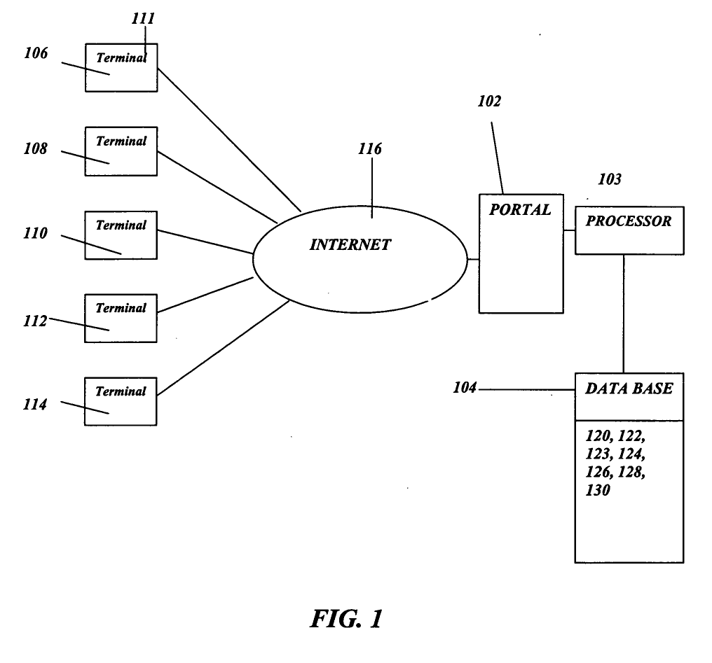

Turning now to FIG. 1 a high level architectural view of the hardware and software environment in which the present example of the invention resides is presented. The method and apparatus of the present Invention Disclosure Submission and Approval system is a role-based system for processing invention disclosure form (IDF) submissions via an electronic on-line entry and review of submissions via a web-based portal. The method and apparatus of the present invention provides an on-line portal for the submission of inventions that streamlines the process. This present invention reduces the manual processes and disparate tools that are currently in place today and on the market.

The present invention streamlines the intellectual property management process enabling users such as inventors, employees/contractors to submit their invention ideas in the form of an IDF into an on-line system for consideration of patentability. Inventors/submitters are able to track the progress of their proposed inventions through the on-line portal. In particular, information about the IDF submission is available on-line with notifications provided of status changes, availability for review by committee and outside counsel and final filing at the USPTO. The method and apparatus provided by the present invention improve efficiency by reducing the time to submit, review, and approve an invention or idea and file a patent application on the invention or idea at a patent office. All submission content is stored in the database for tracking, reporting and generating reports on metrics.

As shown in FIG. 1, a plurality of users connect to a portal 102 via data entry and viewing terminals 111 linked to the portal though the internet 116 or another communication network. The portal users may assume various roles comprising but not limited to administrators 106, patent committee members 108, inventors 110, in-house legal team 112 and outside counsel 114. The portal 102 runs on a processor 103 such as a Sun Microsystems Solaris computer with memory and disk storage. The platform is provided with disk or other types of storage 104 for storage of related data in a database. The database contains passwords 126 for each of the various roles users undertake in interacting with the portal. The related data may include, but is not limited to, invention disclosure forms (IDF's) 124 which describe an idea for an invention, prior art 122 such as technical articles or advertisements relating to the invention or one or more patent applications or issued patents describing or relating to the invention.

A hierarchical list of key words 120 is stored in the data base reflecting keywords related to the invention. For example, a keyword such as, “Voice-Over-IP” may include: VoIP, packets, packet-based communication, IP communication, etc. as a hierarchical list of keywords. The N-level hierarchy structure goes from broad (abstract) at the highest (Nth) level to more specific at each succeeding lower level. Thus, when a high level key word is selected a user is presented with an option of additional keywords on a second more specific level of keywords. Accordingly, when a user selects a keyword on the second level of the hierarchy, the present invention presents keywords on a third more specific level to the user. The process of deeper more specific levels of keywords continues until the Nth level of an N level hierarchy of keywords is reached or the user chooses to escape from the sequence via user input from the terminal. Alternate keywords are also presented based on the first few letters of a keyword input. Keywords sharing the first letters typed are presented as alternate keywords for selection to the user.

The keyword list can be supplemented with additional key words by a user of the system, such as an administrator and an inventor. Business rules 128 are created and stored in the database, which are used to infer from the keywords appearing in the IDF, which products, markets, business units and technologies 130 are associated with the IDF. The associated products, markets and technologies for the IDFs can be selected by a user or automatically inferred from keywords associated with a particular object IDF. Each IDF and its associated products, markets and technologies are stored in a data base and referenced by a unique reference number for the IDF.

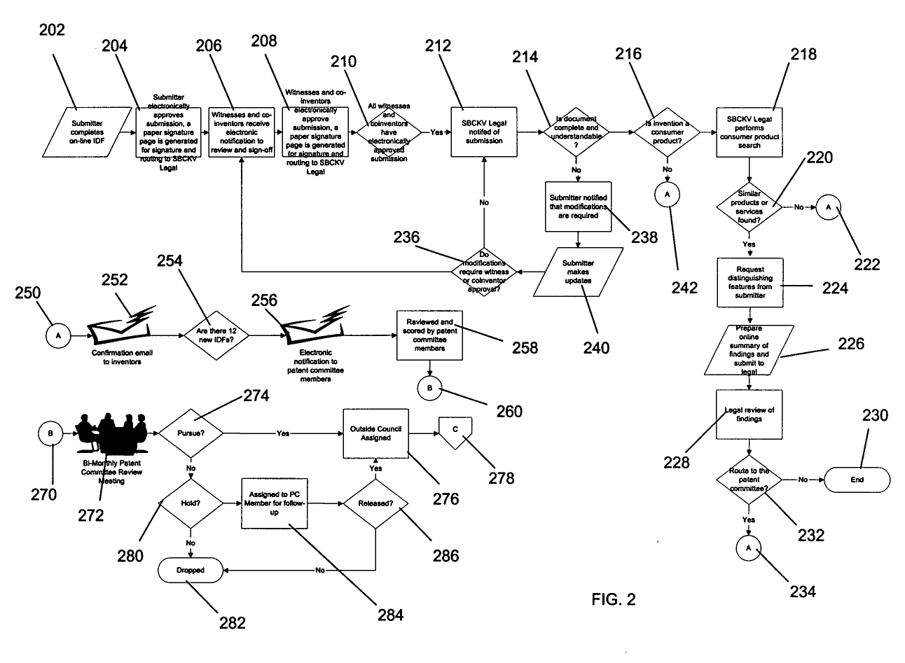

Turning now to FIG. 2, a user (inventor, employee/contractor) completes an on-line web IDF form 202. This allows the user (inventor, employee/contractor etc.) to input information about the invention into an IDF. The IDF is saved in the database and assigned a unique IDF identifier or number as a draft until the inventor is ready to submit the IDF for review. The inventor(s) and witnesses are named on the IDF. Once the IDF is submitted, witnesses and co-inventors receive electronic notification such as an email or call via the portal to approve and sign-off on the invention 206 described in the IDF. The present invention generates email notifications via the portal to the inventor(s) and witnesses requesting submission of the IDF document with their signature.

A printed version of the IDF is generated for signature and routed to the in-house Legal team. Inventor(s) and witnesses electronically approve the submission via portal's Approval icon 204 presented to the user via the terminal 111. Each user assumes one or more roles, such as system administrator, docketing administrator, inventor, in-house legal team, outside counsel and executive or administrative assistant, among others. Users can be automatically assigned to particular IDFs or groups of related IDFs and other documents based upon their role. A user can be manually added to a group access for a number of related IDFs. Further, users can be excluded from a group access automatically based upon their role or can be manually excluded. While assignment to an IDF allows a user to access related IDFs, it does not necessarily provide full access to all data and/or documents in the data base. Such access is also governed by the user's role. Access is based on temporary passwords. For example, an assigned outside counsel may be given a password that allows restricted access in the data base to patent applications and prior art related to the IDF, however, the access and password can be terminated upon filing of the patent application for the IDF. Likewise, temporary access to office actions can be granted related to similar prior art or patents when an office action is received. This temporary access to office actions can be terminated upon filing of a response to the office action.

Additional inventors and witnesses for an IDF document also generate a copy of the IDF document for their respective signatures and route the signed IDF to the in-house Legal team. The system of the present invention generates an IDF tracking number for tracking and reporting purposes. Once all the witnesses and co-inventors have electronically approved the IDF submission 208, 210 the in-house legal team is notified of the IDF submission via a system generated notification 212. If the legal team determines that the submission is not complete or the technology description is not understandable 214, then the submitter is notified 238 by a system generated notification that modifications to the IDF are required. The submitter makes the appropriate modifications 240 to the submission via a web form and electronically resubmits the modified submission. The in-house legal team is contacted via email or another electronic communication for further processing. If the modification requires witness or coinventor approval 236 the modified IDF is sent back to the witnesses or coinventors for approval 206. Confirmation emails are sent to inventor(s) notifying them of any change of status regarding the submission 252.

Once the object IDF document has been reviewed by the in-house Legal team to insure that the IDF is complete and understandable, the present invention applies business rules to determine whether the IDEA described in the document should be the subject of a prior art 242 search. The present invention then generates a notification to the Patent Committee members 256 requesting their recommendation and comments. If the document is searchable internally, based on the configurable business rule 216, the in-house legal team performs the patentability search 218. If prior art that is similar to the described invention 220 is not found, confirmation emails are sent 222, 250, 252 to the inventors. If similar or highly or material or relevant prior art is found, a request is sent to the submitting inventor 224 requesting a description of features distinguishing the idea described in the object IDF from the prior art.

An online summary of the prior art search results findings regarding similar prior art and distinguishing features maybe optionally prepared by the inventor and sent to the in-house legal team based on predetermined business rules 226. The in- house legal team reviews the findings 228 and determines 232 whether to route the invention to the patent committee 234 or end the process 230 possibly with a defensive publication in the public domain or hold the concept as a trade secret. A defensive publication prevents others from later patenting the invention described in the defensive publication.

Upon receipt of a designated (configurable) number of invention disclosure forms (IDFs) 254, for example, 12 IDFs, a notice is sent 256 to the Patent Committee indicating that such a batch of IDFs are ready for review by the Patent Committee members. The Patent Committee members review and score the IDF submissions 258 using business rules to fill in a scoring matrix within the system database. The scoring matrix contains a plurality of categories for scoring the IDF. The Patent Committee signs onto the portal to access the 12 new IDFs for review, scoring and evaluation. The system automatically tracks scores for all the Patent Committee members. Thus, the system allows for automatic ‘pursues’ and ‘drops’. As such, when a high enough score is received for a particular IDF, it is automatically pursued and assigned to outside counsel to draft as a patent application. Similarly, a low score leads to ‘dropping’ the IDF. Thus, a patent application is not merited. The scoring values are assigned based on a scoring index. Upon reaching a particular index score, the IDF can be automatically assigned as ‘pursue’, ‘drop’ or ‘discuss’. The ‘discuss’ IDFs are subsequently discussed at the Patent Committee meeting. If the Patent Committee score is low and the Patent Committee elects not to pursue the invention described in the IDF, the IDF can be put on hold 280 and assigned to a Patent Committee member for follow up 284. Upon follow up, the IDF is reviewed and released 286 and assigned to outside counsel 276, dropped 282, or held as a trade secret. Once a decision has been made to pursue the submission 274, then the method and apparatus of the present invention routes the IDF to outside legal counsel 276. Assignment of outside counsel is discussed below.

In the present example of the invention, the method and apparatus generates a notification 302 and a password for the assigned outside counsel of newly assigned IDF submission. Outside counsel perform the appropriate course of action including an initial patentability search on the IDF and updates the status of the IDF in the system 304. All prior art as defined in the relevant patent laws (e.g., 35 USC §§102-Novelty, 103-Obviousness), found by outside counsel in a patentability search or turned in by the inventors, etc. is evaluated by outside counsel and the in-house legal team. Patentability of the invention over the prior art is discussed with the inventors and in-house legal team 306. The prior art is associated with the IDF number for access within the data base. Thus a cumulative prior art archive is available for subsequent searching.

If the invention is believed to be patentable over the prior art 308, outside counsel is assigned to draft a patent application from the IDF 310. All inventors are asked to apprise outside counsel of any prior art relating to the IDF. The term outside counsel used herein refers to an individual attorney or a section of attorneys at a firm. Alternately, a group of in-house attorneys can play the same role as outside counsel depending on the configuration of the legal department in a corporation or company. The drafted application is subsequently routed to associated inventors for review and comment 312. Comments are returned to outside counsel 314 and once the application is finalized, it is filed with the USPTO and/or another patent office such as a receiving office for the World Intellectual Property Organization (WIPO) for a Patent Cooperation Treaty filing. Outside counsel use a terminal 111 provided by the present invention to enter status and information regarding the IDF and the ensuing patent application. Once the application is filed with the USPTO 316, outside counsel updates the status through the system portal. Notification is sent to the in-house legal team for approval of the update 318. Once approved by the in-house legal team, a record is written to the system 320 and confirmation sent to the inventors 322.

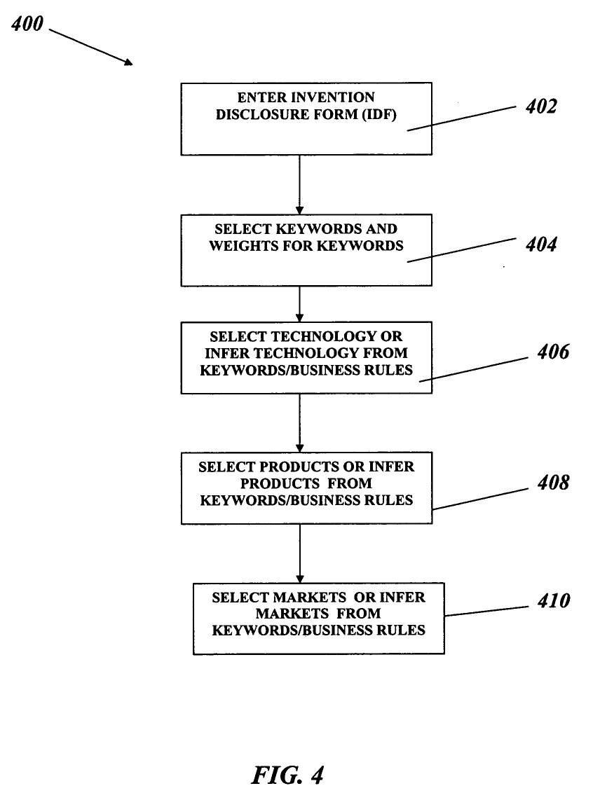

Turning now to FIG. 4, FIG. 4 is an illustration 400 of an example of the functions performed in selecting and identifying key words from an IDF as the IDF is entered into the database. The IDF text and figures are input to the database by typing, email and/or scanning the text and figures 402 or another method through data terminals 111. The IDF is then stored in the database 104. The keyword list 120 is retrieved from the database 104. Each IDF is scanned for Keywords from the list and are highlighted. As an IDF is entered, an inventor is given the opportunity to highlight additional keywords that appear in the particular IDF. The highlighted keywords can be selected to be added to the keywords associated with the particular IDF 404. Keywords appearing in a particular IDF are flagged and can be selected to be associated with the particular IDF having unique IDF number. A list of selected keywords appearing in an IDF is presented to a user so that the user can assign a weight to each of the selected keywords. The user may also allow the system to assign equal weights to each keyword by default. Additional related keywords are presented via a pull down menu from which an inventor or administrator may select to add keywords associated with the IDF. A set of business rules 128 is downloaded from the database and used to infer characteristics for the IDF such as technology 406, product 408 and market 410 categories based on the keywords associated with the IDF. The categories and business rules are entered into the database 104 by the administrator. Business rules are used to infer which business units 130 responsible for particular products, technologies and markets are related to an IDF. The technology 406, product 408 and market 410 categories may be selected by a user as well.

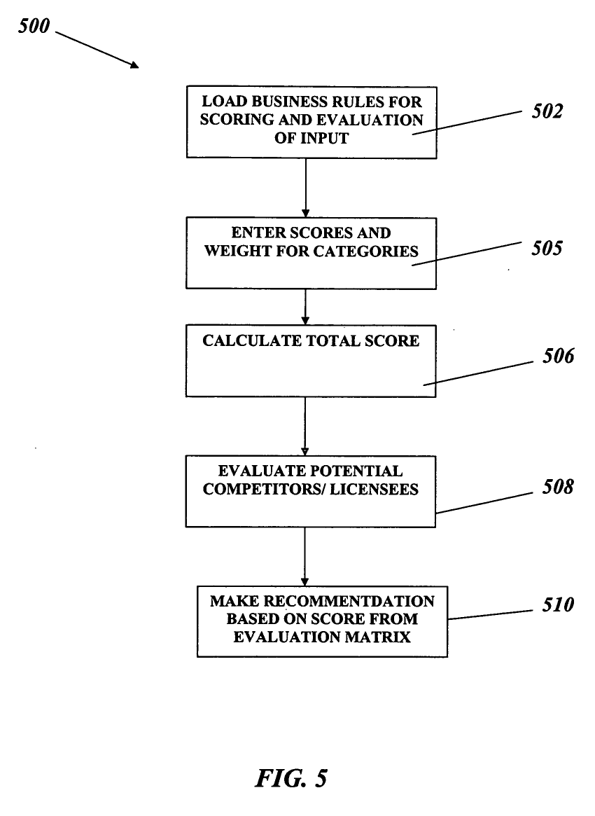

Turning now to FIG. 5, an example of exemplary functions 500 performed during evaluation and scoring of an IDF idea by a Patent Committee is presented. A set of business rules is loaded 502 and scores and weights are entered for the business rule defined categories 505. The business rules are used to evaluate the input. In the present example the input is an IDF but could be any input. The present invention can be used to evaluate any given input based on a set of given business rules for calculating a total score 506 for the input. For example, the IDF idea is evaluated based on configurable business rules as to potential licensees and competitors 508. Similarly, the IDF idea can be evaluated for: technical merit, disruptive technology, industry coverage, invention visibility (direct infringement), revenue potential and any other criteria. A recommendation is made base on the total score from an evaluation matrix and evaluation potential licensees and competitors 510. Also presented here is a method of categorizing scores and associated functionality. Thus, when a score is within a particular range, the IDF will be automatically pursued. Similarly, if the IDF falls within another lower range, the IDF is automatically dropped. Lastly, if the IDF score falls within yet another middle range, a discussion is made at the Patent Committee. Of course, the method taught here takes into account the averaged score for each IDF from all the Patent Committee members and then automatically assigns the appropriate function to each IDF: pursue, drop or discuss.

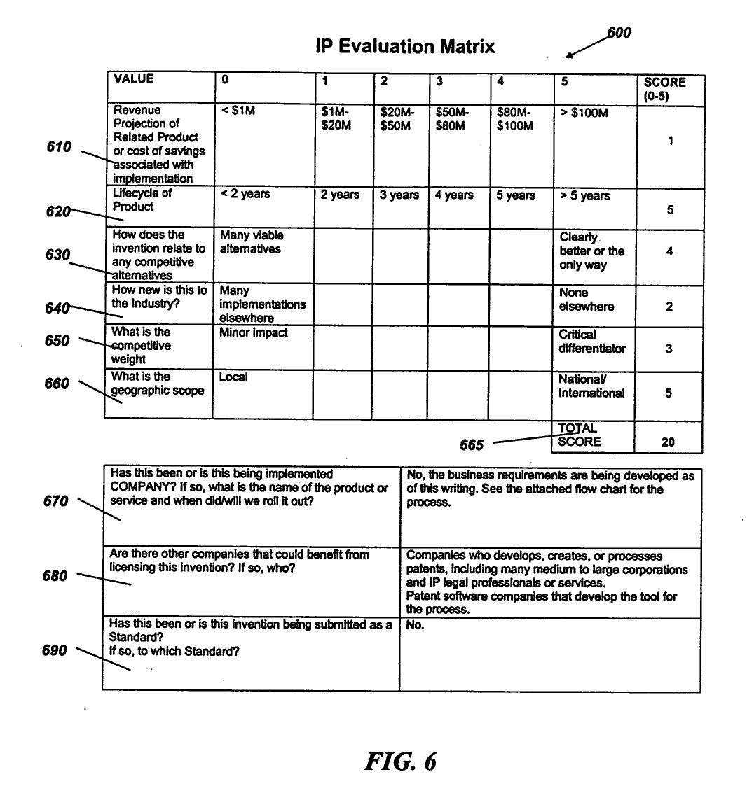

Turning now to FIG. 6, in the present example, a set of business rules for filling in scores in an evaluation matrix 600 for scoring an idea described in the IDF is provided. The business rules are stored in the database and relate to weighted scoring for categories relevant to the IDF idea, such as revenue projection 610, life cycle 620, relation to competition 630, novelty in industry 640, competitive weight 650 and geographic scope of the invention 660. As shown in FIG. 6, a revenue projection 610 and a life cycle 620 for the idea described in the IDF are entered by the inventor and/or Patent Committee, each having a score of 0-5. How the invention is related to competitive product(s) 506 is given a score from 0-5 by the inventor and/or Patent Committee. How new the idea is in industry 640 is given a score of 0-5 by the inventor and/or Patent Committee. The competitive weight 650 for the idea is given a score of 0-5 by the inventor and/or Patent Committee. The geographic scope 660 of the invention is given a weight of 0-5 by the inventor and/or Patent Committee. The scores are entered into an evaluation matrix and stored in the data base.

A patent committee score is entered and recorded for each category in the evaluation matrix 600. Each category score can also be assigned a weight. For example, as high (3), medium (2) or low (1) so that more heavily weighted category scores have more influence than lesser weighted category scores in the associated determination as to what course to take (pursue, discuss, drop) on a given IDF idea. Each evaluation matrix category score (0-5) is multiplied by its assigned weight (high (3), medium (2) or low (1)) to determine a weighted score for the category. A total score 665 for the IDF idea is then calculated by adding together the individually weighted scores. Also during the scoring, the name of an implemented product or service can be identified 670. A list of potential licensees can also be identified 680. Whether the invention has been submitted as an industry standard is entered and submitted 690. The Patent Committee uses the scores, licensing input and industry standard data in deciding whether to pursue a patent on an IDF idea. It should be understood that the scoring provided above is exemplary and that any number of scoring methods maybe used.

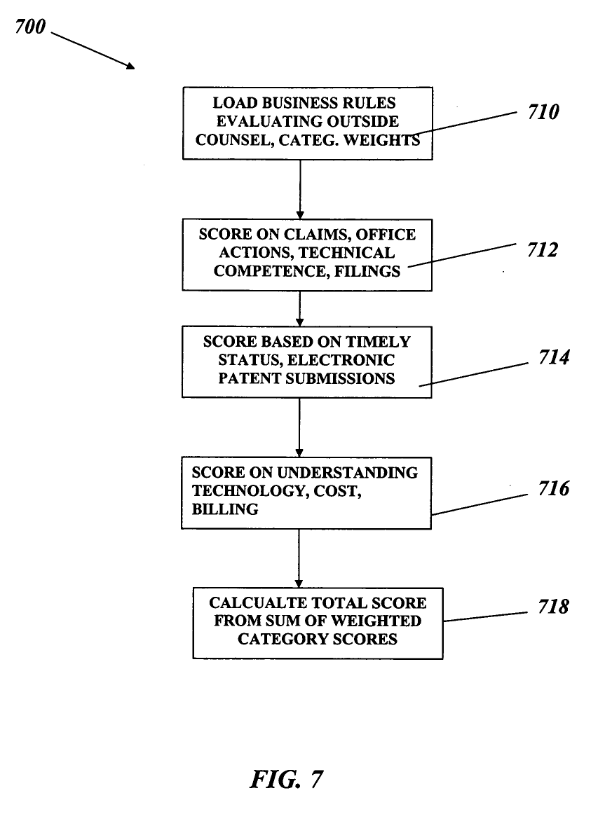

Turning now to FIG. 7, some of the functions of the present invention that are performed for evaluating outside counsel are shown 700. The inventors and in-house legal team evaluate outside counsel. Initially a set of business rules for evaluating outside counsel are loaded 710. The business rules pertain to scoring for evaluation of outside counsel's claim drafting, response to office actions, technical comprehension, patent application filing 712, timely and complete status reports, electronic submission of patent applications 714, overall patent quality, timely response, billing and cost 716. Each category is scored and weighted as high (3), medium (2) or low (1). Each category score (0-5) is multiplied by its weight (high (3), medium (2) or low (1)). The total score of all categories after weighting are added to a total score 718. Individual scores within a category are also available in the data base for decisions related to an individual category such as technical competence in a particular technological field for a given attorney.

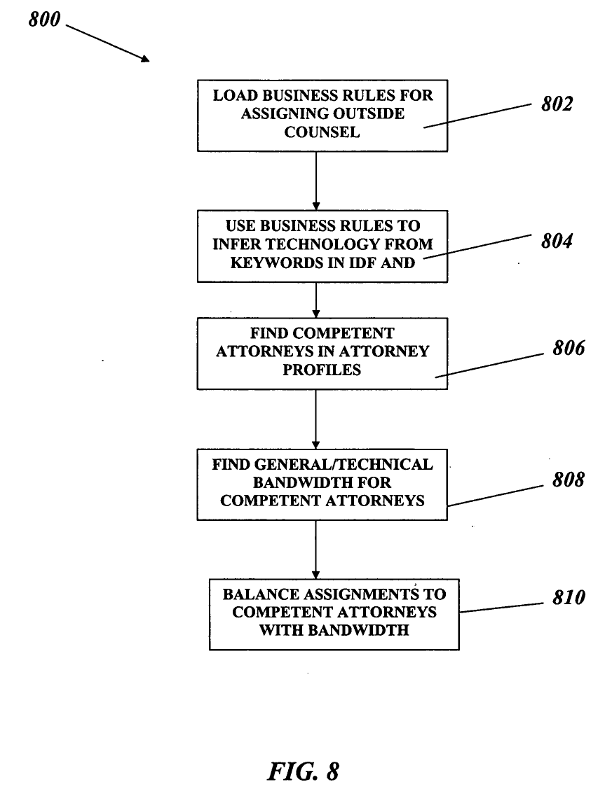

Turning now to FIG. 8, some of the functions 800 that can be performed in assigning outside counsel to patentability searches and drafting patent applications is illustrated. A set of configurable business rules for assigning outside counsel are retrieved from the data base 802. The technical area for the IDF under consideration for assignment is inferred from the key words using business rules 804. The business rules infer relevant technical categories from keywords selected or scanned and found automatically in the IDF. In the case of patent applications and issued patent claims, business rules are used to infer IDF related technical categories from the abstract, summary of invention, claims and detailed description of the invention 804. Each outside counsel has a profile in the data base and has an associated technology competence/understanding score associated with the attorney profile for each technology (e.g., digital subscriber lines, voice over internet protocol, interactive television). Inventors are required to evaluate the outside counsel prior to receiving their award fee as an inventor to enforce participation in the evaluation. A list of appropriate outside counsel are identified based on a search in the attorney profiles 123 for technical competence in the relevant technology for the IDF idea is retrieved from the data base 806. Each outside counsel's technical competence in an particular IDS idea art (as a firm and/or as an individual attorney) is rated as high, medium or low for various technical categories. Two such technical art categories could be, for example, Voice over Internet Protocol (VoIP) or Digital Subscriber Lines (DSL).

The attorney profile also contains a field or area indicating availability to perform work assignments (band-width) in general and bandwidth in the specific technology area related to the IDF idea. The outside counsel's technical and/or general bandwidth can be determined 808 by subtracting the outside counsel's current general and/or technology specific back log of assigned IDFs from the average output of patent applications drafted by the outside counsel per month. The bandwidth can be assigned a value of high (3), medium (2) or low (1). For example, if the outside counsel usually produces 10 patent applications per month and has a backlog of 25 applications all of which have pending for less than one week, it would be expected that the current backlog would take two and one-half months to work off. Thus, any new work would be performed after two and one-half months. Urgency can be set at high (one week), medium (two months) and low (three months). An attempt is made to balance the load or number of assignments so that assignments are efficiently shared between competent outside counsel 810. Load balancing helps to achieve efficient patent application drafting and filing without inordinate delay due to overburdening some outside counsel and neglecting others. The estimated time for completion (ETC) for a patent application based on the IDF can be estimated from start dates for the assigned IDFs pending with the outside counsel, average IDF completion time, and the amount of time elapsed since assignment of the IDF(s). The backlog is evaluated for the outside counsel in general and in the IDF specific technology area to arrive at a bandwidth score of high (3), medium (2) or low (1). Pending IDFs can be sorted by technology area and cumulative time pending with outside counsel to arrive at a bandwidth in a specific technological area. An appropriate outside counsel is thus assigned to draft the patent application as a developer or patent application drafter.

The IDF idea can be assigned an urgency factor of high (3), medium (2) or low (1). The IDF technology can be assigned a criticality factor of high (3), medium (2) or low (1). For example, a particular IDF idea may be urgent because there is a pending public disclosure at a meeting or trade show and the patent application needs to be filed before the public disclosure. The same IDF idea may also involve a technology that has been deemed a critical technology that is strategically important to a business plan. If the outside counsel bandwidth (availability to perform a work assignment) is greater than or equal to the urgency factor and the technical competence is greater than or equal to the outside counsel criticality factor, then the IDF is assigned to the outside counsel. Thus, the selected outside counsel has the bandwidth and technical competence to meet the demands of the project and draft the patent application or perform another relevant project as desired. Additional criteria can be used to evaluate particular or select outside counsel for a given IDF. A notification is sent to the selected outside counsel that IDFs are available for review in the data base. The assigned outside counsel is also assigned a password which gives the outside access to the IDF and temporarily gives the outside counsel access to related or associated patent applications, issued patents and prior art. The password is sent to the assigned outside counsel with a notice to sign on to the portal and download the assigned IDFs. The related IDFs, prior art patent applications and patents accessible via the password are determined by business rules that group together related patents and prior art that deals with related technologies, products or markets. The relationships between IDFs, prior art and patent applications are determined based on the appearance of key words associated with or located in the IDFs, prior art and patent applications. The keywords located in the IDFs, prior art and patent application can be weighted as high (3), medium (2) and low (1) so that the appearance of a more heavily weighted keyword has more influence than the appearance of lesser weighted keyword.

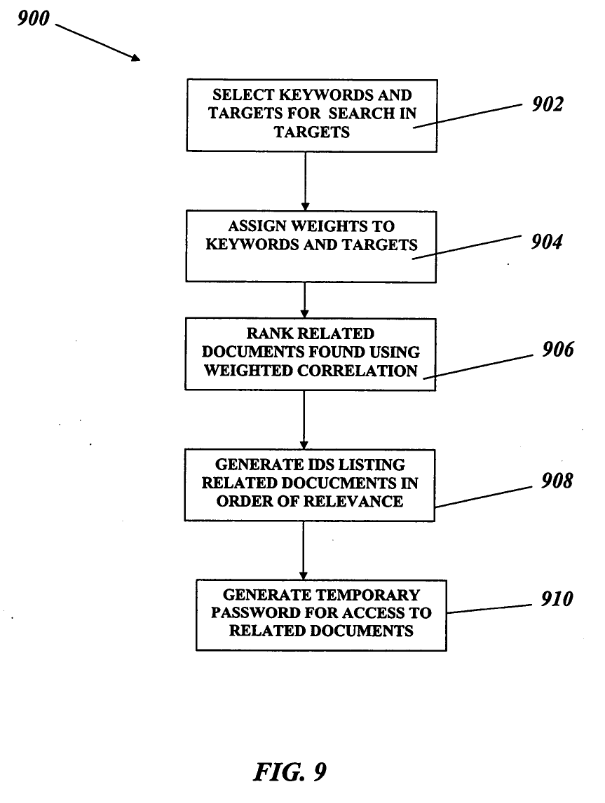

Turning now to FIG. 9, users can select keywords within an IDF for finding related patents and patent applications 900. The keywords for a given IDF are searched in the various selected targets such as sections of patent applications and issued patents: e.g., claims, abstract, summary of the invention or detailed description of the invention 902. Users assign weights to keywords and keyword targets, for example, high (3), medium (2) or low (1) 904. For example, suppose an IDF deals primarily with a topic described by a first key word, and secondarily deals with a topic described by a second and third keyword. In this case, a high weight (3) could be assigned to the first key word and a medium (2) or low (1) weight assigned to the second and third keywords. A user can also assign a source weight, high (3), medium (2) or low (1) weight for each target or source used for searching out keywords 904. The source weight can be added to the keyword weight or the source weight can be multiplied by the keyword weight. In the case of a patent application, a high weight (3) could be assigned to keywords found in the claims and a medium weight (2) could be assigned to the keywords found in the abstract and summary of the invention. A low weight (1) could be assigned to keywords found in the detailed description of the invention. Thus, based on their relative assigned weights, an appearance of the first key word (having a greater weight) rates higher than an appearance of the second keyword (having a lesser weight) when both are found in the claims, that is, found in the same target or source. In addition, the appearance of a key word in the claims rates higher (claims having been assigned a source weight of 3) than the appearance of the same keyword in the abstract (having been assigned a source weight of 2). A user can also assign a high (3), medium (2) or low (1) weight to each of the technologies, products or markets associated with a give IDF. Again, the plurality of weights (source, keyword and technology, etc.) associated with a given keyword can be multiplied or added to getting to obtain a combined keyword weight. The weighting enables a focused or weighted correlation among keywords, products, technologies and markets, etc. rather than a flat correlation wherein all matches of keywords have equal weight or effect on the correlative score. The correlative score is based on the number of matches between keywords from the IDF found in the prior art and patent applications or patents. The correlative score is greater for the appearance of a key word having a high weight than for the appearance of a keyword having a low or medium weight. The prior art documents, patents and patent applications are listed in order according to their weighted correlative score 906.

A proposed information disclosure statement (IDS) for an object IDF idea is automatically prepared for filing with the USPTO 908. The proposed IDS includes all prior art for the IDF related patents, documents and patent applications. Patent applications or patents and documents are associated with the object IDF through keywords. The keywords associate the prior art with the object IDF through related technology, markets and products. All relevant art found during a patentability search for the IDF is also added to the IDS. Prior art is evaluated for relevance to a given object IDF based on an applicable legal standard for patentability. The present invention correlates weighted key words in the object IDF with keywords in the prior art documents (articles, publications, patent applications, issued patents) and other IDFs in the database which are deemed related to the object IDF by a correlation of keywords. The outside counsel or in-house legal team reviews the automatically generated IDS to add prior art found in the patentability search and to remove art not considered relevant to the IDF. The outside counsel's password access to related issued patents, patent applications, prior art and files histories for the related patents and patent application is terminated once the patent application is filed or when the patent application issues depending on the rules set up by the administrator 910.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computerized method for processing an idea, comprising:
accessing a description of the idea;
identifying a keyword in the description; and
processing the idea based on the keyword.

2. The method of claim 1, wherein processing further comprises inferring from the keyword a category for the idea comprises at least one of the set consisting of a technology, market and product.

3. The method of claim 1, wherein processing further comprises finding the keyword in another document to identify a related document relating to the idea.

4. The method of claim 3, further comprising:
ranking a plurality of related documents based on a weight of at least one of the set consisting of a keyword weight and a target weight.

5. The method of claim 3, wherein the documents comprises at least one of the set consisting of issued patents, patent applications, publications and idea descriptions.

6. The method of claim 3, further comprising:
generating a password that allows access to the description of the idea and the related document.

7. The method of claim 3, further comprising:
generating a proposed information disclosure statement including the related document.

8. The method of claim 2, further comprising:
assigning a developer to the idea based on at least one of the set consisting of competence in the technology and available bandwidth.

9. A computerized method for evaluating a concept comprising:
accessing a description of the concept; and
evaluating the concept based on at least one business rule.

10. The method of claim 9, wherein the business rule further comprises at least one rule for scoring a plurality of categories.

11. The method of claim 10, wherein the categories are weighted, the method further comprising:
calculating a total score for the weighted categories.

12. A computerized method for assigning keywords in a document comprising:
selecting a first keyword in a document;
presenting a second keyword related to first selected key word; and
highlighting selected keywords that appear in the document.

13. The method of claim 12, wherein presenting further comprises presenting additional keywords related to keywords that appear in the document.

14. A computer readable medium, comprising a diskette containing instructions that when executed by a processor performs a method for processing an idea, the method comprising:
accessing a description of the idea;
identifying a keyword in the description; and
processing the idea based on the keyword.

15. The medium of claim 14, wherein in the method, processing further comprises inferring from the keyword a category for the idea comprises at least one of the set consisting of a technology, market and product.

16. The medium of claim 14, wherein in the method, processing further comprises finding the keyword in another document to identify a related document relating to the idea.

17. The medium of claim 16, the method further comprising:
ranking a plurality of related documents based on a weight of at least one of the set consisting of a keyword weight and a target weight.

18. The medium of claim 16, wherein in the method, the documents comprise at least one of the set consisting of issued patents, patent application publications and additional idea descriptions.

19. The medium of claim 14, the method further comprising:
generating a password that allows access to the description of the intellectual property and the related document.

20. The medium of claim 16, the method further comprising:
generating a proposed information disclosure statement including the related document.

21. The medium of claim 15 the method further comprising:
assigning a developer to the intellectual property based on at least one of the set consisting of competence in the technology and available bandwidth.

22. A computer readable medium containing instructions that when executed by a processor performs a method for evaluating a concept comprising:
accessing a description of the concept; and
evaluating the concept based on at least one business rule.

23. The medium of claim 22, wherein in the method the business rule further comprises at least one rule for scoring a plurality of categories.

24. The medium of claim 23, wherein in the method the categories are weighted, the method further comprising:
calculating a total score for the weighted categories.

25. A computer readable medium containing instructions that when executed by a process perform a method for computerized method for assigning keywords in a document comprising:
selecting a first keyword in a document;
presenting a second keyword related to first selected key word; and
highlighting selected keywords that appear in the document.

26. The medium of claim 25, wherein in the method presenting further comprises presenting additional keywords related to keywords that appear in the document.
